(19) United States
(12) Patent Application Publication
(10) Pub. No.: US 2007/0077370 A1
(43) Pub. Date: Apr. 5, 2007

(54) Gasoline-impermeable coatings

(75) Inventor: John Ulcar, Mississauga (CA)

Correspondence Address: TRASK BRITT, P.O. BOX 2550, SALT LAKE CITY, UT, 84110, US

(73) Assignee: Crosslink Technology Inc., Toronto (CA)

(21) Appl. No.: 11/243,444

(22) Filed: Oct. 4, 2005

(51) Int. Cl. C08J 7/18

(52) U.S. Cl. 427/553

(57) ABSTRACT

A coating that can be adhered to a polyethylene gasoline container to substantially reduce its gas permeability, and a gasoline container treated with such a coating. A single-component cationic curing composition with increased impermeability to gasoline vapor uses a bis “F” epoxy in combination with a catalyst and oxetane. The invention takes advantage of a narrower ultraviolet absorption spectrum of the bis “F” epoxy, whereby ultraviolet radiation outside the UV absorption spectrum of the bis “F” will activate the catalyst, the highly active superacid from the antimonate anion, without any significant reduction of the cationic curing reaction. In the preferred embodiment the bis “F” and oxetane combination is used along with various additives included for flow and cosmetic purposes.

### TECHNICAL FIELD

This invention relates to coatings. In particular, this invention relates to gas impermeable coatings for gasoline containers and the like.

### BACKGROUND

Gasoline containers are made from polyethylene. A typical gasoline container experiences a permeation rate of about 30 g/m²/day, resulting in the loss of a considerable amount of gasoline vapor into the environment. This extent of gasoline pollution caused by this problem is so substantial that the Environmental Protection Agency has announced a directive requiring that losses due to gasoline permeation be reduced to 1.5 g/m²/day.

Polyethylene is a preferred material for gasoline containers despite its permeability, because of its other physical and chemical properties, including resistance to decomposition. One possible method of reducing the permeability of polyethylene is to coat the container with a material having a lower permeability than polyethylene. However, polyethylene has a low surface energy, and consequently a very low adhesion, which makes coating the container difficult. There are techniques available to increase the adhesion of polyethylene sufficiently to allow a coating to adhere with reasonable permanence, for example chemical etching.

However, the production of a coating material that both adheres to polyethylene and has the required low permeability to gasoline has been problematic. One type of coating suitable for surface modified polyethylene containers, which uses cationic ultraviolet (UV) technology, has been available for many years. The resins of choice for this type of coating have predominantly been cycloaliphatic resins modified with polycaprolactone polyols, combined with a UV activated catalyst (typically triaryl sulphonium hexafluorophosphate). As in the case of standard two-component epoxies, these UV cured systems had generally good mechanical and chemical properties, as well as the advantage of very fast curing under UV lights (seconds as opposed to minutes), which made them suitable for mass production applications.

However, the high permeability to gasoline of such coatings has rendered them unsuitable for reducing the permeability of gasoline cans. The use of an aromatic epoxy in a cationic curing compound is capable of providing the desired low permeability to gasoline, providing a much tighter crosslink structure, but is problematic from the curing standpoint because absorption in the ultraviolet range for these types of epoxies is very high.

For example, FIG. 1 illustrates diglycidyl ether of bisphenol “A,” an example of a standard bis “A” structure, which is one of the most popular epoxy resins used for two-component systems. It has high UV absorption in most of the same range as the catalyst, as shown in FIG. 2. Therefore, the ultraviolet radiation needed by the UV activated catalyst to cure the compound is absorbed by the epoxy, which interferes with the curing process. As such these types of epoxies are considered to be too slow for use in cationic ultraviolet applications.

### SUMMARY OF THE INVENTION

The present invention provides a coating that can be adhered to a polyethylene gasoline container to substantially reduce its gas permeability, and a gasoline container treated with such a coating. The invention comprises a single-component cationic curing composition having greatly increased chemical resistance to gasoline, and in particular a very high impermeability to gasoline. The composition of the invention creates a coating having a very close crosslink structure, capable of reducing gas permeability to below 1.5 g/m²/day.

The invention accomplishes this using a bis “F” epoxy compound in combination with an oxetane compound, which when mixed with a catalyst (activator) creates a cationic curing compound having the desired chemical properties. The use of an aromatic epoxy compound in such an application has previously been dismissed as unviable, because ultraviolet absorption by aromatic epoxy compounds is known to interfere with the excitation of the catalyst and thus the formation of the superacid that causes the epoxy molecules to react. However, the invention takes advantage of a UV absorption spectrum of the bis “F” epoxy compound, whereby ultraviolet radiation outside the UV absorption spectrum of the bis “F” epoxy compound will activate the more active hexafluoro antimonite ion without any significant reduction of the cationic curing reaction.

In the preferred embodiment the bis “F” epoxy compound and oxetane compound combination is used along with various additives included for flow and cosmetic purposes. The combination of a catalyst and a resin comprising the bis “F” epoxy compound (bis “F” epoxy resin) provides a quick reaction, which renders the composition suitable for use as a coating material in the mass production of gasoline containers, along with superior chemical resistance properties including a very low permeability to gasoline vapor.

The invention thus provides a curable compound for use as a coating for a container, comprising a cationic photoinitiator, oxetane compound, and a bis “F” epoxy compound, whereby upon application of the curable compound to a container and exposure to ultraviolet radiation, the curable compound cures and adheres to the container to decrease a permeability of the container.

The invention further provides a method of decreasing permeability of a gasoline container, comprising the steps of a) coating the container with a curable compound comprising a cationic photoinitiator, oxetane compound and a bis “F” epoxy compound; and b) curing the curable compound using ultraviolet radiation, whereby the curable compound cures and adheres to the container to decrease a permeability of the container to gasoline vapor.

### BRIEF DESCRIPTION OF THE DRAWINGS

In drawings which illustrate by way of example only a preferred embodiment of the invention:

FIG. 1 illustrates an example of a bis “A” structure;

FIG. 2 is a graph illustrating the ultraviolet absorption spectrum of the standard bis “A” compounds illustrated in FIG. 1;

FIG. 3 illustrates the structure of bisphenol F;

FIG. 4 illustrates the structure of a bis “F” epoxy compound;

FIG. 5 illustrates examples of cycloaliphatic resins;

FIG. 6 is a graph illustrating the ultraviolet absorption spectrum of the cycloaliphatic resins illustrated in FIG. 5;

FIG. 7 illustrates polycaprolactone;

FIG. 8 illustrates triaryl sulphonium hexafluoro phosphate;

FIG. 9 illustrates examples of mixed arylsulphonium hexafluoroantimonate salts;

FIG. 10 is a graph illustrating the ultraviolet absorption spectrum of the mixed arylsulphonium hexafluoroantimonate salts illustrated in FIG. 9;

FIG. 11 is a graph illustrating the UV emission spectrum of a standard industrial mercury bulb (irradiation energy vs. wavelength);

FIG. 12 is a perspective view of a gasoline container treated with the coating of the invention; and

FIG. 12A is an enlarged sectional view of a wall of the gasoline container of FIG. 12.

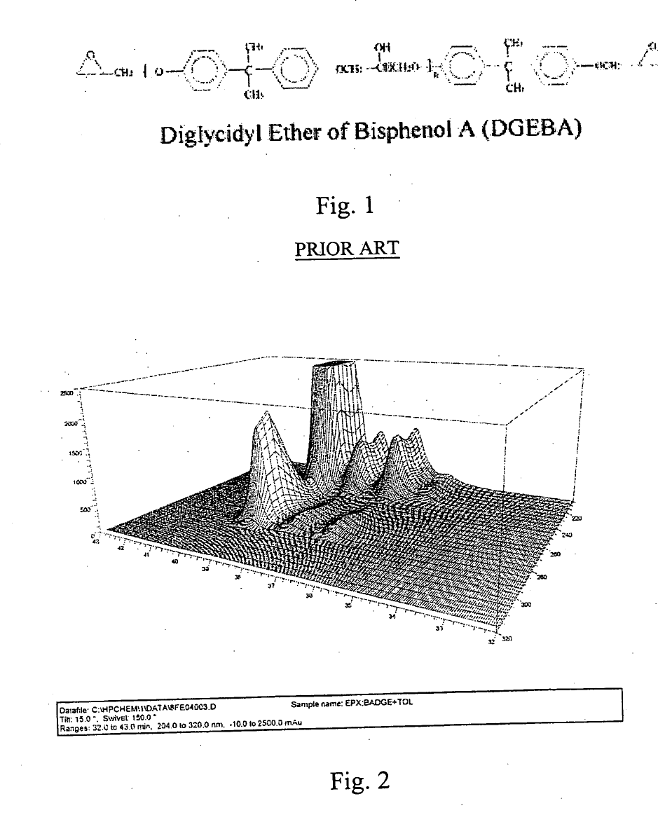

### DETAILED DESCRIPTION OF THE INVENTION

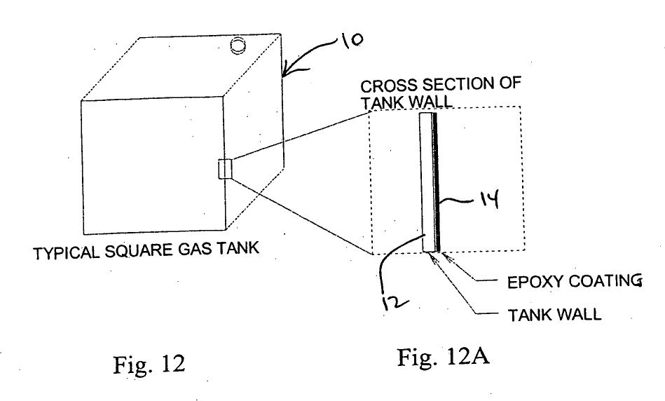

FIG. 12 illustrates a typical gas container 10 having a wall 12. The method and curable compound described herein can be used to apply a coating 14 to the gasoline container 10, to reduce the permeability of the wall 12 to gasoline vapor.

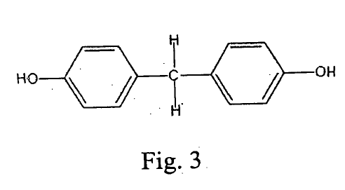

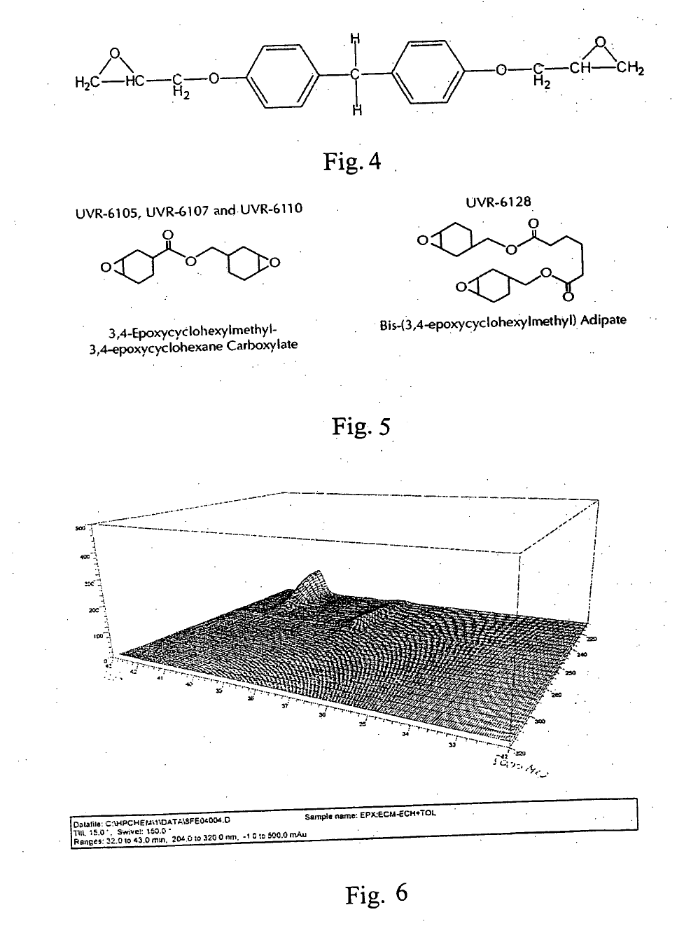

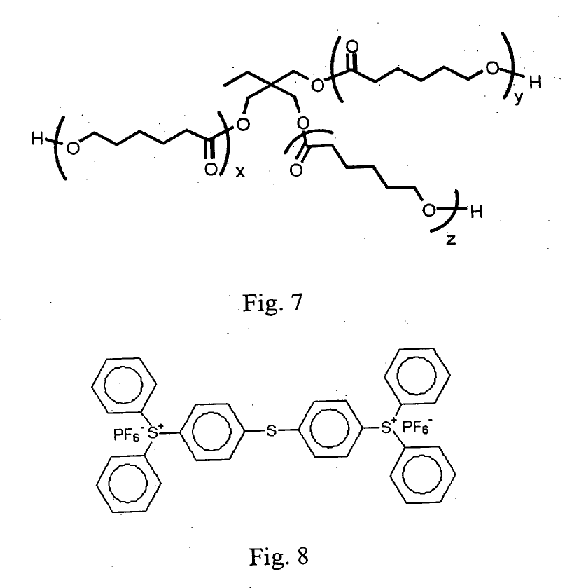

As is well known to a person skilled in the art, bis F epoxy compounds or bis “F” epoxies are derived from bisphenol F by processes known in the art. FIG. 3 illustrates the structure of bisphenol F. FIG. 4 illustrates the structure of a typical bis “F” epoxy compound that is used to form a typical bis F epoxy resin. As is known to a person skilled in the art, there are many different bis “F” epoxies that can be generated from bisphenol F. Bis “F” resins are primarily used in high performance applications because of their high temperature resistance and superior chemical resistance.

The bis “F” resin is mixed with an oxetane compound to impart some flexibility in the coating without sacrificing substantial permeation resistance. Oxetane does not absorb light in the UV spectra and therefore does not interfere with the UV curing process. Suitable oxetane compounds for the purposes of the present include the following formula (I): 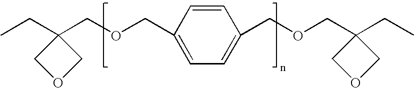
n=1, 2, or 3;
and the following formula (II): 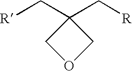
R═H, OH, CH3, CH2OH, CH2ONO2, ETC.
R′═H, OH, CH3, CH2OH, CH2ONO2, ETC.
In addition, oxetane can be the oxetane compound for the purposes of the present invention.

An alternative additive is polycaprolactone, illustrated in FIG. 7, but it does not appear to be as effective as oxetane or other oxetane compounds for this particular application.

The bis “F” epoxy resin/oxetane compound combination is mixed with a cationic photoinitiator, also commonly known as a “catalyst” or “activator.” Cationic photoinitiators are frequently compounds found in classes such as the triaryl sulfonium, tetraaryl phosphonium, and diaryl iodonium salts of large protected anions (hexafluoro phosphates or antimonates). FIG. 8 illustrates by way of example triaryl sulphonium hexafluoro phosphate which is a suitable catalyst for use in the present invention.

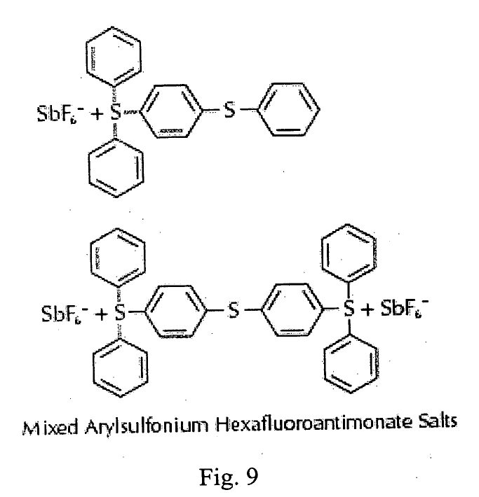

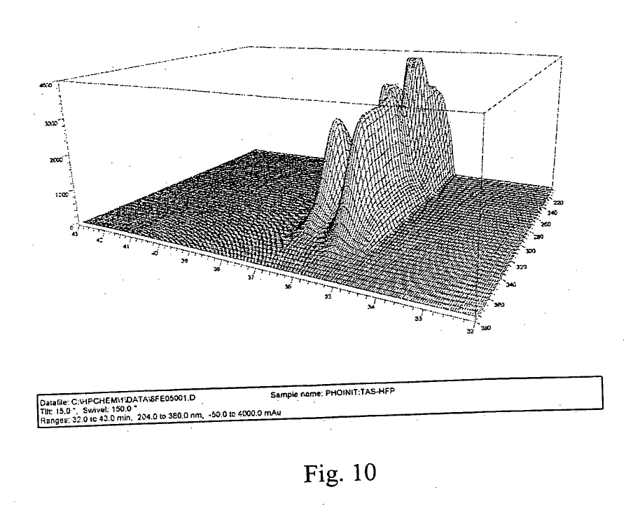

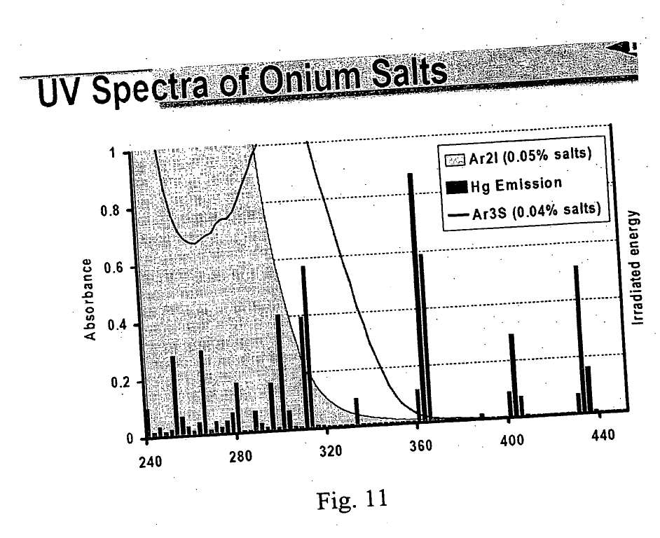

FIG. 9 illustrates examples of mixed arylsulphonium hexafluoroantimonate salts. These compounds are the most suitable catalysts for use in the present invention because the stronger anions produced are more effective in accelerating the reaction. For example, FIG. 10 is a graph illustrating the ultraviolet absorption spectrum of the mixed arylsulphonium hexafluoroantimonate salts illustrated in FIG. 10, from which it can be seen that the absorption band falls outside the absorption band of the bis “F” epoxy compounds illustrated in FIG. 4. FIG. 11 is a graph illustrating the UV emission spectrum of a standard industrial mercury bulb (irradiation energy as a function of wavelength), which peaks in the range of the bis “F” epoxy resin. Other suitable catalysts, by way of example only, include triaryl sulphonium hexafluoroantimonate or triaryl iodonium hexafluoroantimonate.

To create the compound of the invention, the ingredients are mixed one at a time. Preferably the catalyst is added to the mixture last, ensuring a complete mixed solution.

In use, a polyethylene gasoline container 10 such as that illustrated in FIG. 12 is preferably suitably pre-treated using physical or chemical etching, or any other process designed to improve the adherence of surface of the gasoline container. A curable compound according to the invention is applied to the container wall 12, for example sprayed on or the container 10 is dipped into the compound, and the curable compound is subsequently cured by exposure to ultraviolet radiation for the required interval (typically a few seconds) to create the low-permeability coating 14. Additional coats 14 may be applied in like fashion, according to the desired level of impermeability, however a single coating of the preferred embodiment should lower the permeability of the container sufficient to meet proposed regulatory standards.

Other additives which can optionally be added, for the purpose indicated, are: cycloaliphatic epoxies, for viscosity modification; low molecular weight polyols, for hardness and flexibility modification; and photosensitizers to increase the activity of light absorption by the catalyst.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A curable compound for use as a coating for a container, comprising:
a cationic photoinitiator;
oxetane compound; and
a bis “F” epoxy compound;
whereby upon application of the curable compound to a container and exposure to ultraviolet radiation, the curable compound cures and adheres to the container to decrease a permeability of the container.

2. The curable compound of claim 1 wherein the permeability is decreased with respect to gasoline vapor.

3. The curable compound of claim 1 wherein the cationic photoinitiator comprises a triaryl sulfonium, tetraaryl phosphonium, or diaryl iodonium salt of hexafluoro phosphate or antimonite.

4. The curable compound of claim 1 wherein the bis “F” epoxy compound is (2,2,-bis[p-(2,3-epoxypropoxy)phenyl]-methane).

5. The curable compound of claim 1 further comprising at least one cycloaliphatic epoxy for viscosity modification.

6. The curable compound of claim 1 further comprising at least one low molecular weight polyol for hardness or flexibility modification.

7. The curable compound of claim 1 further comprising at least one photosensitizer to increase the activity of light absorption by the catalyst.

8. The curable compound of claim 1 wherein the oxetane compound corresponds to the following formula (I): 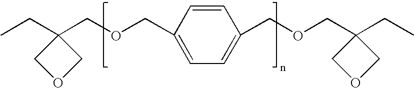
n=1, 2, or 3.

9. The curable compound of claim 1 wherein the oxetane compound corresponds to the following formula (II): 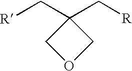
R═H, OH, CH3, CH2OH, CH2ONO2, ETC.
R′═H, OH, CH3, CH2OH, CH2ONO2, ETC.

10. A method of decreasing permeability of a gasoline container, comprising the steps of:
a. coating the container with a curable compound comprising a cationic photoinitiator, an oxetane compound and a bis “F” epoxy compound, and
b. curing the curable compound using ultraviolet radiation,
whereby the curable compound cures and adheres to the container to decrease a permeability of the container to gasoline vapor.

11. The method of claim 10 wherein the cationic photoinitiator comprises a triaryl sulfonium, tetraaryl phosphonium, or diaryl iodonium salt of hexafluoro phosphate or antimonite.

12. The method of claim 10 wherein the bis “F” epoxy is (2,2,-bis[p-(2,3-epoxypropoxy)phenyl]-methane).

13. The method of claim 10 wherein the curable compound further comprises at least one cycloaliphatic epoxy for viscosity modification.

14. The method of claim 10 wherein the curable compound further comprises at least one low molecular weight polyol for hardness or flexibility modification.

15. The method of claim 10 wherein the curable compound further comprises at least one photosensitizer to increase the activity of light absorption by the catalyst.

16. The method of claim 10 wherein the oxetane compound corresponds to the following formula (I): 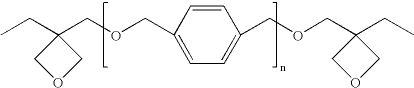
n=1, 2, or 3.

17. The method of claim 10 wherein the oxetane compound corresponds to the following formula (II): 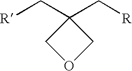
R═H, OH, CH3, CH2OH, CH2ONO2, ETC.
R′═H, OH, CH3, CH2OH, CH2ONO2, ETC.
